(19) United States
(12) Patent Application Publication
(10) Pub. No.: US 2007/0152168 A1
(43) Pub. Date: Jul. 5, 2007

(54) SUBSTRATE PROTECTING MEMBER AND METHOD OF FORMING ANALYSIS SAMPLE USING THE SAME

(76) Inventors: Taek-Jin Lim, Hwaseong-si (KR); Jin-Sung Kim, Suwon-si (KR); Sang-Ick Lee, Gunpo-si (KR)

Correspondence Address: F. CHAU & ASSOCIATES, LLC, 130 WOODBURY ROAD, WOODBURY, NY, 11797, US

(21) Appl. No.: 11/617,159

(22) Filed: Dec. 28, 2006

(30) Foreign Application Priority Data
Dec. 29, 2005 (KR) 2005-132953

(51) Int. Cl. G21G 5/00

(52) U.S. Cl. 250/492.1

(57) ABSTRACT

In a substrate protecting member and a method of forming an analysis sample using the same, the substrate protecting member includes a protective layer attached to a semiconductor substrate to protect a defect portion of the semiconductor substrate and a sensing line including first, second and third conductive lines located on the protective layer. The first conductive line extends in a first direction. The second conductive line extends to an edge of the protective layer in a second direction different from the first direction. The second and third conductive lines are electrically connected to first and second end portions of the first conductive line, respectively. The third conductive line extends to an edge of the protective layer in the second direction.

### CROSS-REFERENCE TO RELATED PATENT APPLICATION

This applcation claims priority under 35 USC § 119 to Korean Patent Application No. 2005-132953, filed on Dec. 29, 2005, the disclosure of which is incorporated herein by reference in its entirety.

### BACKGROUND OF THE INVENTION

1. Technical Field

The present disclosure generally relates to a substrate protecting member and a method of forming an analysis sample using the substrate protecting member. More particularly, the present disclosure relates to a substrate protecting member protecting a defect portion of a substrate when a polish for forming an analysis sample is performed and automatically controlling the polish, and a method of forming an analysis sample from which the defect portion is exposed by the substrate protecting member.

2. Discussion of Related Art

Generally, semiconductor devices are manufactured through the repetition of unit processes such as film formation to form patterns having electrical characteristics on a wafer, etching, diffusion, metal wiring processes, etc. Recently, semiconductor devices have been developed to be highly integrated and with finer features for implementing various functions and storing a maximum amount of data. Accordingly, the significance of technologies and analysis equipment for performing structural and chemical analyses has increased. In an analysis of To analyze defects in semiconductor devices, equipment such as a scanning capacitance microscope (SCM), transmission electron microscope (TEM) and secondary electron microscope (SEM), etc may be used for the inspection of localized portions.

The SCM is mainly used for confirming with the naked eye whether an impurity is properly implanted beneath the surface of semiconductor substrate. The TEM and SEM are mainly used for confirming with the naked eye whether thin film layers comprising the semiconductor devices are properly formed.

To analyze a defect portion an analysis sample is formed. To form the analysis sample to confirm the vertical profile of the defect portion, peripheral areas of an analysis point in a semiconductor substrate are polished or etched, thereby exposing the side of the analysis point.

For example, to form an analysis sample used for the TEM and SCM, a preliminary analysis sample cut into a predetermined size is polished in the direction where the analysis point is extended, while the preliminary analysis sample is polished, its progress has to be repeatedly confirmed through an optical microscope. Several inspections may be required for confirming whether the analysis point is exactly exposed to the side of the preliminary analysis sample. Thus, it can be time consuming to complete an analysis sample. Furthermore, the analysis sample may not be formed in a case where the polishing process exceeds the analysis point, wherein that the analysis point is partially or completely removed.

In general, the polishing process is performed at various speeds, such that large amounts of silicon may be rapidly removed at an early stage and lesser amounts may be slowly removed thereafter. However, it may not be easy to time the change of the speed.

To reduce the frequency with which the polishing progress is confirmed using an optical microscope, systems and methods for accurately confirming a proximity to the analysis point while performing the polishing process are required. Existing methods of optically monitoring a polishing progress are limited because it is not easy to optically detect defect portions due to the water and slurry used in the polishing process.

A method of controlling a desired thickness in formation of the analysis sample, for example, is disclosed in Japanese Laid-Open Patent Publication No. 8-110288. Japanese Laid-Open Patent Publication No. 8-110288, discloses a polishing apparatus for controlling a desired thickness of the analysis sample in which a protruded portion is formed on a side of a region to place an analysis sample so that a polishing process is completed when the polish apparatus contacts the protruded portion. The polishing apparatus controls the thickness of an analysis sample by controlling the height of the protruded portion.

Since the polishing apparatus controls the height of the protruded portion to adjust the thickness of an analysis sample, a process for accurately calculating a relation between the height of an analysis sample and the height of the protruded portion is required. However, it may be difficult to accurately calculate this relationship. Existing methods, such as that disclosed in Japanese Laid-Open Patent Publication No. 8-110288, only control the thickness of an analysis sample. In such methods it may be difficult to perform a polishing process to accurately expose an analysis point of the analysis sample on a surface.

### SUMMARY OF THE DISCLOSURE

According to an exemplary embodiment of the present invention, a substrate protecting member includes a protective layer and a sensing line. The protective layer is attached to a semiconductor substrate to protect a defect portion of the semiconductor substrate.

The sensing line includes first, second and third conductive lines located on the protective layer. The first conductive line extends in a first direction. The second conductive line extends to an edge of the protective layer in a second direction different from the first direction. The second conductive line is electrically connected to a first end portion of the first conductive line. The third conductive line extends to an edge of the protective layer in the second direction. The third conductive line is electrically connected to a second end portion of the first conductive line.

According to an exemplary embodiment of the present invention, a method of forming an analysis sample includes providing a substrate protecting member including a protective layer and a sensing line. The sensing line includes a plurality of conductive lines located on the protective layer. A preliminary analysis sample is formed by attaching the substrate protective member to a substrate having an analysis point such that a first conductive line is electrically connected to an outer portion of the analysis point. Electric signal detectors are electrically connected to end portions of a second and a third conductive line to detect electric signals transferred through the first to third conductive lines. The preliminary analysis sample is polished in a direction substantially parallel with the first conductive line. Whether the first conductive line is broken is determined by determining a signal change in the electric signal detector. An analysis sample having a side from which the analysis point is exposed is formed by stopping the polishing process when the first conductive line adjacent to the analysis point is broken.

According to an exemplary embodiment of the present invention, a method of forming an analysis sample includes providing a substrate protecting member including a protective layer and a sensing line is provided. The protective layer has a substantially plate shape. The protective layer is transparent and includes an insulating material. The sensing line includes first to third conductive lines located on the protective layer. The first conductive line extends in a first direction. The second conductive line extends to an edge of the protective layer in a second direction different from the first direction. The second conductive line is electrically connected to a first end portion of the first conductive line. The third conductive line extends to an edge of the protective layer in the second direction. The third conductive line is electrically connected to a second end portion of the first conductive line. A preliminary analysis sample is formed by attaching the substrate protective member to a substrate having an analysis point such that the first conductive line is electrically connected to an outer portion of the analysis point. A controlling part is electrically connected to end portions of the second and third conductive lines. The controlling part controls operations of a polishing device using an electric signal provided by the first to third conductive lines.

The preliminary analysis sample is polished in a direction substantially parallel with a direction in which the first conductive line is extended while driving the controlling part. Whether the first conductive line is broken may be determined using an electric signal generated by the controlling part to change a supply of a slurry composition.

The controlling part may include a first switch, a second switch and a third switch. The first switch receives an electric signal from the third conductive line that is electrically connected to the first lines conductive line. The first switch controls a first slurry provider of the polishing device according to whether the first conductive line is broken. The second switch receives electric signals from the third conductive line, wherein the third conductive line is electrically connected to the first conductive line and electrically connected to a fourth conductive line paired with the first conductive line. The second switch controls a second slurry provider of the polishing device according to whether the first and fourth conductive lines are broken. The third switch receives electric signals from the third conductive line, wherein the third conductive line is electrically connected to the fourth conductive line and electrically connected to fifth conductive line paired with the fourth conductive line. The third switch controls a third slurry provider of the polishing device according to whether the second and fifth conductive lines are broken.

According to an exemplary embodiment of the present invention, an analysis sample from which the analysis point P is exposed may be formed using a substrate protecting member confirming the polished amount of a preliminary analysis sample white the preliminary analysis sample is polished.

### BRIEF DESCRIPTION OF THE DRAWINGS

The present invention will become more apparent to those of ordinary skill in the art when descriptions of exemplary embodiments thereof are read with reference to the accompanying drawings.

FIG. 1 is a perspective view illustrating a substrate protecting member in accordance with an exemplary embodiment of the present invention.

FIG. 2 is a perspective view illustrating a substrate protecting member in accordance with an exemplary embodiment of the present invention.

FIG. 3 is a perspective view illustrating a substrate protecting member in accordance with an exemplary embodiment of the present invention.

FIG. 4 is a flow chart illustrating a method of forming an analysis sample using the substrate protecting member of FIG. 1, according to an exemplary embodiment of the present invention.

FIGS. 5 to 7 are perspective views illustrating a method of forming the analysis sample using the substrate protecting member of FIG. 1 according to an exemplary embodiment of the present invention.

FIG. 8 is a schematic perspective view illustrating a method of forming an analysis sample using the substrate protecting member of FIG. 2, according to an exemplary embodiment of the present invention.

FIG. 9 is a circuit diagram illustrating an operation controlling circuit included in a controlling part of FIG. 8, according to an exemplary embodiment of the present invention.

FIG. 10 is a schematic perspective view illustrating a method of forming an analysis sample by using the substrate protecting member of FIG. 3, according to an exemplary embodiment of the present invention.

### DESCRIPTION OF EXEMPLARY EMBODIMENTS

Exemplary embodiments of the present invention will be described in detail with reference to the accompanying drawings. In the drawings the sizes and relative sizes of layers and regions may be exaggerated for clarity.

Like reference numerals refer to similar or identical elements throughout the description of the figures.

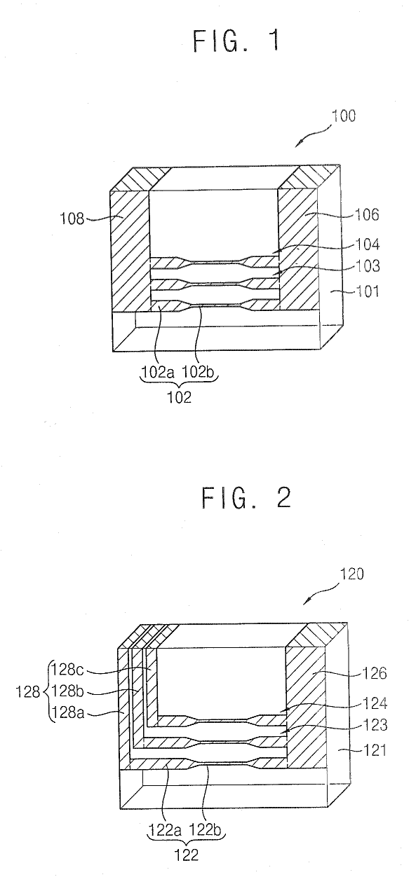

FIG. 1 is a perspective view illustrating a substrate protecting member in accordance with an exemplary embodiment of the present invention.

The substrate protecting member 100 of FIG. 1 may include a protective layer 101 and a sensing line (not shown). The protective layer 101 may have an insulating property. The protecting layer 101 may include a transparent material. For example, the protective layer 101 may include a glass. The protecting layer 101 may have a substantially plate shape. The sensing line may be provided on the protective layer 101 to control a polishing rate.

The protective layer 101 may be attached to a semiconductor substrate having an analysis point to protect the analysis point. The protective layer 101 may include a transparent material so that the semiconductor substrate having the analysis point positioned below the protective layer 101 may be observed by the naked eye.

The sensing line may include a plurality of first conductive lines 102, 103 and 104, a second conductive line 106, and a third conductive line 108. The first conductive lines 102, 103 and 104 may extend in a first direction. The second conductive line 106 may extend in a second direction, which may be different from the first direction. For example, the second direction may be substantially perpendicular to the first direction. As shown in FIG. 1, the second conductive line 106 may be connected to first ends of the first conductive lines 102, 103 and 104. The third conductive line 108 may be connected to second ends of the first conductive lines 102, 103 and 104. The second ends may be substantially opposite to the first ends.

In an exemplary embodiment of the present invention, the first conductive lines 102, 103 and 104 are electrically connected to the second conductive line 106 and the third conductive line 108, and the first conductive lines 102, 103 and 104 may be electrically connected to one another even when the first conductive line 102, 103 or 104 is broken.

The first conductive lines 102, 103 and 104, the second conductive line 106, and the third conductive line 108 may include doped poly-silicon, aluminum, copper, titanium, tungsten and/or gold. The first conductive lines 102, 103 and 104, the second conductive line 106 and the third conductive line 108 may include substantially the same material. It is to be understood that the first conductive lines 102, 103 and 104, the second conductive line 106 and the third conductive line 108 may include different materials.

The first conductive lines 102, 103 and 104 may extend substantially in parallel with a face of the semiconductor substrate that is to be polished to form an analysis sample. The substrate protecting member 100, according to an exemplary embodiment of the present invention described in connection with FIG. 1 employs three first conductive lines 102, 103 and 104. As shown in FIG. 1, the first conductive lines 102, 103 and 104 are spaced apart from one another.

End portions 102a of the first conductive lines 102, 103 and 104 that are adjacent to the second conductive line 106 or the third conductive line 108 have first widths. Central portions 102b of the first conductive lines 102, 103 and 104 may have second widths substantially smaller than the first widths. For example, the first width may be about 100 μm to about 500 μm. The second width may be about 1 μm to about 5 μm.

The second and third conductive lines 106 and 108 may extend to an edge of the protective layer 101 opposite to a face of the protective layer 101 that is to be polished to form the analysis sample.

According to an exemplary embodiment of the present embodiment, a polished amount may be efficiently estimated by determining whether the first conductive lines 102, 103 and 104 are broken or not broken. The number of the first conductive lines may be three, for example, as described in connection with FIG. 1. The number of the first conductive lines may be one or two. The number of the first conductive lines may be at least four.

FIG. 2 is a perspective view illustrating a substrate protecting member in accordance with an exemplary embodiment of the present invention.

The substrate protecting member 120 of FIG. 2 may be substantially similar to the substrate protecting member 100 of FIG. 1 except for the shape of a sensing line employed for measuring a polished amount.

The protective layer 121 included in the substrate protecting member 120 may be substantially similar to the protective layer 101 in FIG. 1.

Referring to FIG. 2, the sensing line may include a plurality of first conductive lines 122, 123 and 124, a second conductive line 126 and a plurality of third conductive lines 128. The first conductive lines 122, 123 and 124 may extend in a first direction. The second conductive line 126 may extend in a second direction, which may be different from the first direction. For examples the second direction may be substantially perpendicular to the first direction. As shown in FIG. 2, second conductive line 126 is electrically connected to first ends of the first conductive lines 122, 123 and 124. The third conductive lines 128 are electrically connected to second ends of the first conductive lines 122, 123 and 124, respectively. The second ends may be substantially opposite to the first ends. The number of the first conductive lines may be substantially the same as the number of the third conductive lines.

End portions 122a of the first conductive lines 122, 123 and 124 that are adjacent to the second conductive line 126 or the third conductive lines 128 have first widths. Central portions 122b of the first conductive lines 122, 123 and 124 may have second widths substantially smaller than the first widths. For example, the first width may be about 100 μm to about 500 μm. The second width may be about 1 μm to about 5 μm.

The first conductive lines 122, 123 and 124, the second conductive line 126 and the third conductive line 128 may include substantially the same material but may have a different resistance in accordance with line widths therein. In an exemplary embodiment of the present invention, the line width of the second conductive line 126 where an electric signal is applied is substantially larger than the first widths.

The second and third conductive lines 126 and 128 may extend to an edge of the protective layer 121 opposite to a face of the protective layer 121 that is to be polished to form the analysis sample.

In a case that a first conductive line 122, 123 or 124 is broken, an electric signal may not be transferred to the third conductive line connected to the second end of the broken first conductive line. In an exemplary embodiment of the present invention, whether the first conductive lines are broken or not broken may be efficiently determined to control a polished amount when the analysis sample is formed.

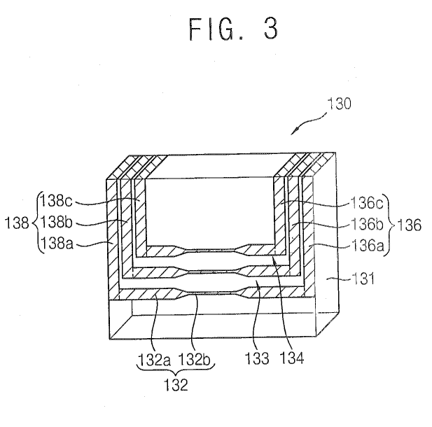

FIG. 3 is a perspective view illustrating a substrate protecting member in accordance with an exemplary embodiment of the present invention.

The substrate protecting member 130 of FIG. 3 may be substantially the same as the substrate protecting member 101 in FIG. 1 except for the shape of a sensing line.

A protective layer 131 included in the substrate protecting member 130 may be substantially the same as the protective layer 101 in FIG. 1.

Referring to FIG. 3, the sensing line may include a plurality of first conductive lines 132, 133 and 134, a plurality of second conductive lines 136 and a plurality of third conductive lines 138. The first conductive lines 132, 133 and 134 may extend in a first direction. The second conductive lines 136 may extend in a second direction, which may be different from the first direction. For example, the second direction may be substantially perpendicular to the first direction. The second conductive lines 136 may be connected to first ends of the first conductive lines 132, 133 and 134, respectively. The third conductive lines 138 may be connected to second ends of the first conductive lines 132, 133 and 134, respectively. The second ends may be substantially opposite to the first ends. The number of the first conductive lines may be substantially the same as that of the second conductive lines. The number of the first conductive lines may be substantially the same as that of the third conductive lines.

End portions 132a of the first conductive lines 132, 133 and 134 that are adjacent to the second conductive lines 136 or the third conductive lines 138 have first widths. Central portions 132b of the first conductive lines 132, 133 and 134 may have second widths substantially smaller than the first widths. For example, the first widths may be about 100 μm to about 500 μm. The second width may be about 1 μm to about 5 μm.

The second and third conductive lines 136 and 138 may extend to an edge of the protective layer 131 opposite to a face of the protective layer 131 that is to be polished to form the analysis sample.

In a case that one of the first conductive lines is broken, the second and third conductive lines that are electrically connected to both sides of the broken first connective line may not be electrically connected. In an exemplary embodiment of the present invention, whether the first conductive lines are broken or not broken may be efficiently determined to control a polished amount when the analysis sample is formed.

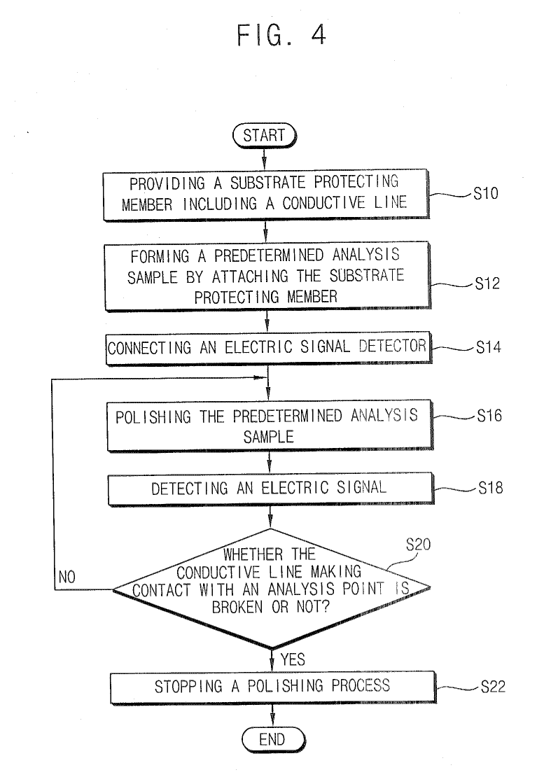

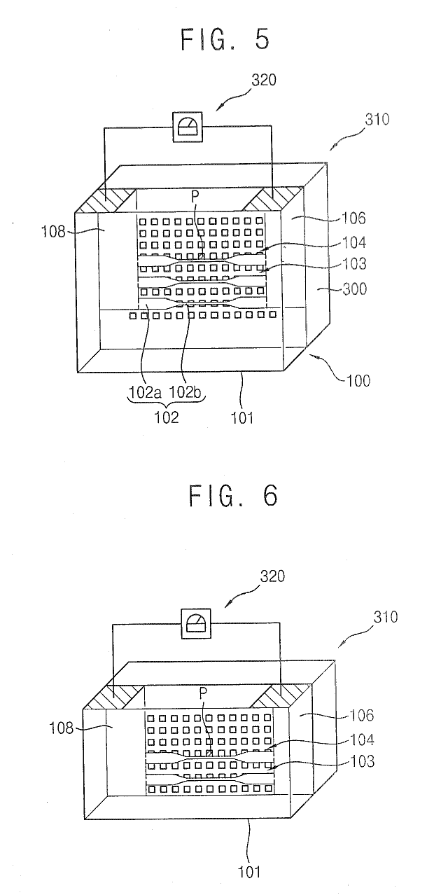

FIG. 4 is a flow chart illustrating a method of forming an analysis sample using the substrate protecting member of FIG. 1, according to an exemplary embodiment of the present invention, FIGS. 5 to 7 are perspective views illustrating a method of forming the analysis sample using the substrate protecting member in FIG. 1 according to an exemplary embodiment of the present invention.

Referring to FIG. 4, a substrate protecting member 100 may be provided in step S10. As illustrated in FIG. 1 the substrate protecting member 100 may include three first conductive lines that are substantially parallel with one another. To facilitate explanation, the reference numbers 102, 103 and 104 of FIG. 4 are associated with the first conductive lines In a direction away from the face initially polished.

As illustrated in FIG. 5, the substrate protecting member 100 may be attached to a substrate 300 including an analysis point P. The analysis point P may have an address where a defect or an electrical failure may be generated.

The substrate protecting member 100 may be attached to a side of the substrate 300 such that the substrate protecting member 120 is substantially in parallel with the side of the substrate 300. The substrate protecting member 100 may be attached to the substrate 300 such that a side portion included in a first conductive line 102, 103 or 104 makes contact with an outer portion of the analysis point P. The second and third conductive lines 106 and 108 may extend to edges of the substrate protecting member 100 substantially opposite to the face of the substrate protecting member 100 that is to be polished.

In an exemplary embodiment of the present invention, a side portion of the first conductive line 104 that is farthest from the face and is to be polished makes contact with the outer portion of the analysis point P. An upper side of the center portion of the conductive line 104 having the first widths substantially smaller than the second width may make contact with the outer portion of the analysis point P. In a case that the analysis point P is exposed through the polished face of the substrate protecting member 100 while polishing the substrate protecting member 100, the conductive line 104 making contact with the outer portion of the analysis point P may be broken.

A thermosetting resin may be used to attach the substrate protecting member 100 to the substrate 300 in a case the thermosetting resin is used, the substrate protecting member 100 may be precisely attached to the substrate 300 when heat is applied to harden the thermosetting resin after the center portion of the conductive line 104 is adjusted to contact the analysis point P on the substrate 300, for example using an optical microscope.

A dummy wafer (not shown) may be attached to a back side of the substrate 300 to protect the substrate 300. A plurality of dummy wafers may be attached to the back side of the substrate 300.

The substrate 300 to which the substrate protecting member 100 is attached may be cut into a size suitable as an analysis sample so that a preliminary analysis sample 310 may be separated from the substrate 300. The substrate 300 may be cut using a cutter, such as for example, a diamond cutter.

Referring to FIGS. 5, 6 and 7, an electric signal detector 320 is connected to both end portions of the second and third conductive lines 106 and 108 to detect an electrical signal transferred through the first conductive lines 102, 103 and 104, the second conductive line 106, and the third conductive lines 108 of the substrate protecting member 100. The electric signal detector 320 may include a device for measuring or applying a voltage and a current.

A predetermined voltage may be applied to both end portions of the second and third conductive lines 106 and 108, for example, using the electric signal detector 320. A current flowing through the first conductive lines 120, 103 and 104, the second conductive line 106, and the third conductive line 108 may be measured. For example, when the predetermined voltage is applied to both end portions of the second and third conductive lines 106 and 108, a first current may flow through the first conductive lines 102, 103 and 104, the second conductive line 106, and the third conductive line 108.

A first polishing process is performed, in step S16, with respect to the preliminary analysis sample 310 in a direction substantially perpendicular to a direction in which the first conductive lines 102, 103 and 104 are extended. In the first polishing process, a polished portion of the preliminary analysis sample 310 is not adjacent to the analysis point P. In an exemplary embodiment of the present invention, a substantially large polishing rate is used in the first polishing process. A diamond pad and a diamond slurry composition may be employed in the first polishing process, for example, to increase the polishing rate.

While the first polishing process is performed, the current flowing through the first conductive lines 102, 103 and 104, the second conductive line 106, and the third conductive line 108 may be measured. A point of time when the first conductive line 102 that is nearest to the polished portion of the substrate protecting member 100 is broken may be obtained by detecting the current during the first polishing process. For example, when the current measured in the first polishing process is substantially smaller than the first current, the first conductive line 102 may be determined as broken.

FIG. 6 is a perspective view illustrating the substrate protecting member 100 and the preliminary analysis sample 310 remaining after the first polishing process is performed, according to an exemplary embodiment of the present invention.

Referring to FIGS. 5 and 6, in a case that the first conductive line 102 is broken in the first polishing process, the first conductive lines 103 and 104 may remain. That is, in a case of three conductive lines, the number of the first conductive lines remaining after the first polishing process is performed may be two. The total resistance of the first conductive lines may be increased when the total number of the first conductive lines is reduced. As a result, a second current substantially smaller than the first current may flow through the first conductive lines 102, 103 and 104, the second conductive line 106, and the third conductive line 108. Whether the first conductive line 102 is broken or not broken may be determined by a variation of current flowing through the first conductive lines 102, 103 and 104, the second conductive line 106, and the third conductive line 108. Using the method described in connection with FIG. 4, a polished amount of the preliminary analysis sample 310 may be obtained.

A portion of the first conductive line 102 having a first line width that is relatively thin may be initially broken. The analysis point P may not be removed before the first conductive line 102 is broken although the first polish is not performed substantially in parallel with the first conductive lines 102, 103 and 104.

After the first conductive line 102 is broken, a second polishing process may be performed on the preliminary analysis sample 310, for example, at a polishing rate substantially smaller than that of the first polish. A silicon carbide (SIC) pad may be used in the second polishing process. An alumina slurry composition having abrasive particles substantially smaller than those of the diamond slurry composition may be used in the second polishing process. A portion of the preliminary analysis sample 310 that is polished in the second polishing process may be substantially nearer to the analysis point P in comparison with that polished in the first polishing process. The second polishing process described above may be necessary to reduce attack of the abrasive particles on a portion of the preliminary analysis point that is to be polished in the second polishing process, and to prevent complete removal of the analysis point by the second polishing process. The second polishing process may be performed at the relatively small polishing rate.

While the second polishing process is performed, the current flowing through the first conductive lines 103 and 104, the second conductive line 106, and the third conductive line 108 may be measured. A point of time when the first conductive line 103 is broken may be obtained by detecting a decrease in the current by a predetermined amount. The second polishing process may be performed until the first conductive line 103 is broken.

After the first conductive line 103 is broken, a third polishing process is performed on the preliminary analysis sample 310, according to an exemplary embodiment of the present invention, at a polishing rate substantially smaller than that of the second polishing process. A silicon carbide (SIC) pad may be used in the third polishing process. An alumina slurry composition or a ceria slurry composition having abrasive particles substantially smaller than those of the alumina slurry composition used in the second polishing process may be used in the third polishing process. A portion of the preliminary analysis sample 310 that is polished in the third polishing process may be substantially nearer to the analysis point P in comparison with that in the second polishing process. The third polishing process described above may be necessary to reduce attack of the abrasive particles on a portion of the preliminary analysis point that is to be polished in the third polishing process, and to prevent complete removal of the analysis point by the third polishing process. The third polishing process may be performed at the relatively a small polishing rate.

While the third polishing process is performed, the current flowing through the first to third conductive lines 104, 106 and 108 may be measured. A point of time when the first conductive line 104 is broken may be obtained by detecting a decrease in the current by a predetermined amount. The third polishing process may be performed until the conductive line 104 is broken in step S20.

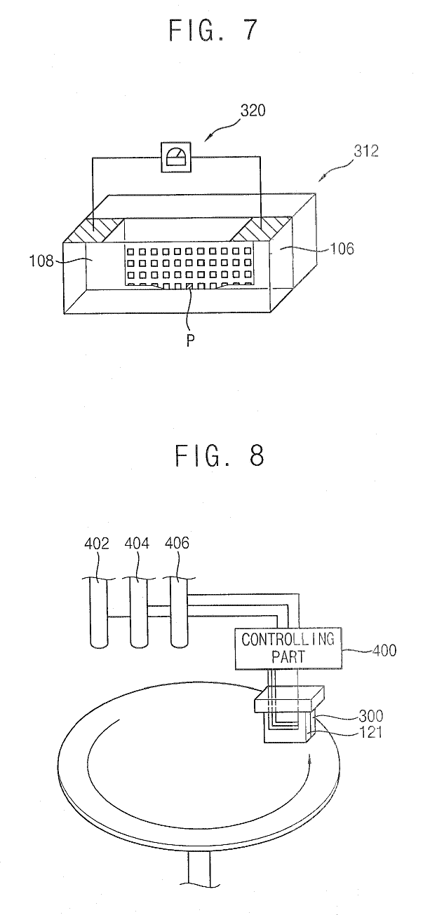

FIG. 7 is a perspective view illustrating the completed analysis sample exposing the analysis point, according to an exemplary embodiment of the present invention.

As illustrated in FIG. 7, in a case that the conductive line 104 is broken, the analysis point P may be exposed from the analysis sample when the conductive line 104 makes contact with the analysis point P. The analysis sample from which the analysis point P is exposed may be completed by polishing the preliminary analysis sample until the analysis point P is exposed in step S22.

In an exemplary embodiment of the present invention, the analysis sample from which the analysis point P is exposed is formed using the substrate protecting member confirming the polished amount of the preliminary analysis sample while the preliminary analysis sample is polished, such that a need to manually and repeatedly conform the polished amount of the preliminary analysis by using an optical microscope may be eliminated, and a time required for forming the analysis sample may be reduced, and the complete removal of the analysis point P due to an exceeding polish may be prevented.

In an exemplary embodiment of the present embodiment, the variation of current flowing through the second and third conductive lines is measured after a predetermined voltage is applied to both ends of the second and third conductive lines. The variation of voltage between both ends of the second and third conductive lines may be measured after a predetermined current is applied to the second and third conductive lines.

The substrate protecting member 100 described in connection with FIG. 1 may be employed to form the analysis sample. The substrate protecting members 120 or 130 described in connection with FIGS. 2 and 3, respectively, may be employed to form the analysis sample. In a case that the substrate protecting members 120 or 130 are employed to form the analysis sample, the second conductive lines are electrically connected to one another and the third conductive lines are electrically connected to one another.

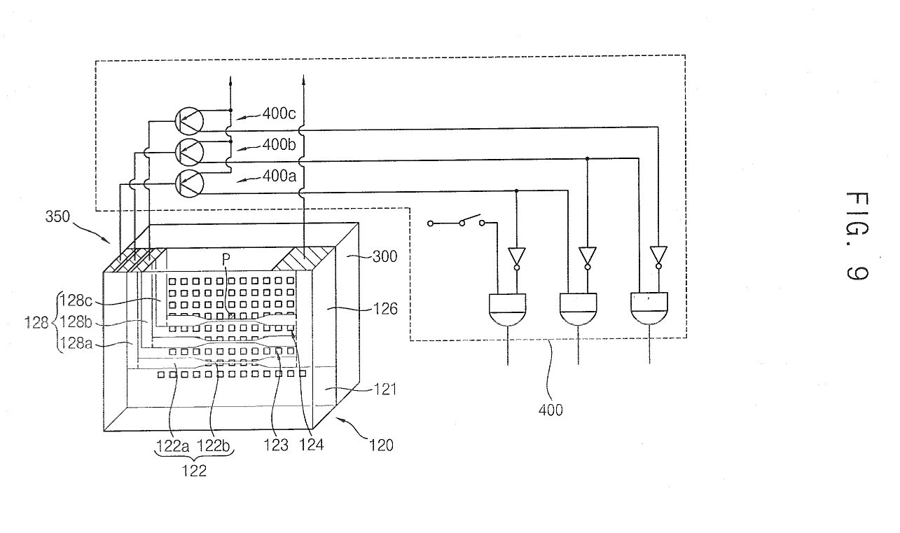

FIG. 8 is a schematic perspective view illustrating a method of forming an analysis sample using the substrate protecting member 120 of FIG. 2, according to an exemplary embodiment of the present invention. FIG. 9 is a circuit diagram illustrating an operation controlling circuit included in a controlling part 400 of FIG. 8, according to an exemplary embodiment of the present invention.

Referring to FIGS. 8 and 9, the substrate protecting member 120 may include the first conductive lines 122, 123 and 124, the second conductive line 126 and the third conductive lines 128a, 128b and 128c. The second conductive line 126 is connected to the first ends of the first conductive lines 122, 123 and 124. The second ends of the first conductive lines 122 123 and 124 are connected to the third conductive lines 128a, 128b and 128c, respectively. To facilitate explanation, the reference numbers 122, 123 and 124 of FIG. 9 are associated with the first conductive lines in a direction away from the face of the substrate protecting member that is initially polished.

The substrate protecting member 120 may be attached to a substrate 300 including an analysis point P.

The substrate protecting member 120 may be attached to a side of the substrate 300 shown in FIG. 9 such that the substrate protecting member 120 is substantially in parallel with the side of the substrate 300. The substrate protecting member 120 may be attached to the substrate 300 such that a side portion included in the first conductive line 122, 123 or 124 makes contact with an outer portion of the analysis point P. The second and third conductive lines 126 and 128 may extend to edges of the substrate protecting member 120 substantially opposite to the face of the substrate protecting member 120 that is to be polished.

In an exemplary embodiment of the present invention, a side portion of the first conductive line 124 that is farthest from the face and is to be polished makes contact with the outer portion of the analysis point P. In an exemplary embodiment of the present invention, an upper side of the center portion of the first conductive line 124 having the first width substantially smaller than the second width makes contact with the outer portion of the analysis point P. In a case that the analysis point P is exposed from the polished face of the substrate protecting member 120 while polishing the substrate protecting member 120, the first conductive line 124 making contact with the outer portion of the analysis point P may be broken.

A dummy wafer (not shown) may be attached to a back side of the substrate 300 to protect the substrate 300. A plurality of dummy wafers may be attached to the back side of the substrate 300.

The substrate 300 to which the substrate protecting member 120 is attached may be cut into a size suitable as an analysis sample so that a preliminary analysis sample 310 may be separated from the substrate 300.

An operation controlling part 400 controlling operations of a polishing device, for example, using signals provided through the first conductive lines 122, 123 and 124, the second conductive line 126, and the third conductive line 128, may be electronically connected to ends of the second and third conductive lines 126 and 128.

The operation controlling part 400 may include a first switch 400a, a second switch 400b and a third switch 400c. The first switch 400a may receive an electric signal from the third conductive line 128a connected to the first conductive line 122 that is farthest from the analysis point P where a defect or a electric failure may exist. The first switch 400a may control operations of a first slurry provider 402 depending on cutting of the first conductive line 122. The second switch 400b may receive an electric signal from the third conductive line 128b, which is electrically connected to the first conductive line 123 that is located next to the first conductive line 122. The second switch 400b may control operations of a second slurry provider 404 depending on cuttings of the first conductive lines 122 and 123. The third switch 400c may receive an electric signal from the third conductive line 128c, which is electrically connected to the first conductive line 124 that is located next to the first conductive line 123. The third switch 400c may control an operation of a second slurry provider 406 depending on cuttings of the first conductive lines 123 and 124. It is to be understood that the first, second and third switches 400a 400b and 400c may be implemented in various configurations.

Hereinafter, an operation controlling circuit included in a controlling part 400 of FIG. 8, according to an exemplary embodiment of the present invention, is illustrated with reference to FIG. 9.

Referring to FIG. 9, the first switch 400a may include a first bipolar transistor (not shown), a first inverter (not shown) and a first AND logic circuit (not shown). The first bipolar transistor is electrically connected to the third conductive line 128a contacting the first conductive line 122 of FIG. 9. The first inverter is electrically connected to a collector of the first bipolar transistor. The first AND logic circuit may receive a signal from the first inverter. An external input portion for inputting an electric signal from an external source may be connected to the first AND logic circuit. The third conductive line making contact with the first conductive line may be electrically connected to a base of the first bipolar transistor. An output portion of the first AND logic circuit may be electrically connected to a driving signal input portion of the first slurry provider.

The second switch 400b may include a second bipolar transistor (not shown), a second inverter (not shown) and a second AND logic circuit (not shown). The second bipolar transistor is electrically connected to the third conductive line 128b making contact with the first conductive line 123 of FIG. 9. The second inverter is electrically connected to a collector of the second bipolar transistor. The second AND logic circuit may receive a signal from the second inverter. An input portion of the second AND logic circuit may be electrically connected to the collector of the first bipolar transistor to input an electric signal from the collector of the first bipolar transistor. The third conductive line 128b making contact with the first conductive line 123 may be electrically connected to a base of the second bipolar transistor. An output portion of the second AND logic circuit may be electrically connected to a driving signal input portion of the second slurry provider.

The third switch 400c may include a third bipolar transistor (not shown), a third inverter (not shown) and a third AND logic circuit (not shown). The third bipolar transistor is electrically connected to the third conductive line 128c making contact with the first conductive line 124 of FIG. 9. The third inverter is electrically connected to a collector of the third bipolar transistor. The third AND logic circuit may receive a signal from the third inverter. An input portion of the third AND logic circuit may be electrically connected to the collector of the second bipolar transistor to input an electric signal from the collector of the second bipolar transistor. The third conductive line 128c making contact with the first conductive line 124 may be electrically connected to a base of the third bipolar transistor. An output portion of the third AND logic circuit may be electrically connected to a driving signal input portion of the third slurry provider.

The first, second and third bipolar transistors may be, for example PNP transistors, The first second and third bipolar transistors may be PMOS transistors. The emitters of the first, second and third bipolar transistors may be electrically connected to one another such that an electric signal may be substantially simultaneously inputted to the emitters.

Variations of the first to third switches may be implemented, for example, using a NAND logic circuit, a NOR logic circuit or an inverter.

Hereinafter a method of forming an analysis sample using the controller 400, according to an exemplary embodiment of the present invention, will be explained.

The controlling part 400 may be operated by applying an electric signal to the controlling part 400. For example, a high signal may be applied to the emitters of the first to third transistors and the input portion of the first AND logic circuit. A high signal may be applied to an input portion connected to the second conductive line 126.

In a case that the controlling part 400 operates using a high signal applied through the second conductive line 126 that is inputted to the base of the first, second and third bipolar transistors, a current does not flow from the emitters to collectors of the bipolar transistors. As a result, the first to third bipolar transistors output a low signal.

Two high signals may be inputted to the first AND logic circuits for example, as described above. High and low signals may be inputted to the second AND logic circuit, and high and low signals may be inputted to the third AND logic circuit. In an exemplary embodiment of the present invention, the first AND logic circuit outputs a high signal and the second and third AND logic circuits output low signals. The high signal outputted from the first AND logic circuit may operate the first slurry provider 402.

A first polishing process may be performed on the preliminary analysis sample 350 in a direction substantially perpendicular to a direction that the first conductive lines 122, 123 and 124 are extended. In the first polishing process, a polished portion of the preliminary analysis sample 350 is not adjacent to the analysis point P. A substantially large polishing rate may be used in the first polishing process. In the first polishing process, a first slurry composition having a first abrasive particle may be provided by the first slurry provider 402. The first abrasive particle included in the first slurry composition may have a relatively large size. For example, the first slurry composition may be a diamond slurry composition. The first polishing process may be performed until the first conductive line 122 is broken.

When the first conductive line 122 is broken in the first polishing process, the signal inputted to the controlling part 400 may be changed. For example, a low signal may be inputted to the third conductive line 128c electrically connected to the first conductive line 122.

A high signal may be inputted to the third conductive lines 128b and 128c that are electrically connected to the first conductive lines 123 and 124, respectively. In such case, a current flows from the emitter to collector of the first bipolar transistor, but the current does not flow from the emitters to collectors of the second and third bipolar transistors.

High and tow signals may be inputted to the first AND logic circuits for example, as described above. High and high signals may be inputted to the second AND logic circuit. High and low signals may be inputted to the third AND logic circuits. The first and third AND logic circuits may output low signals. The second AND logic circuit may output a high signal. The high signal outputted from the second AND logic circuit may operate the second slurry provider 404. The first slurry composition may not be provided from the first slurry provider 402 when the tow signal is outputted from the first AND logic circuit.

When the first conductive line 122 is broken in the first polishing process, a second polishing process may be performed by supplying a second slurry composition having a second abrasive particle, which may have a size substantially smaller than that of the first abrasive particle. Although not shown as such in the drawings, the second polishing process may be performed using a polishing pad substantially different from that used in the first polishing process. The second slurry composition, for example, may be an alumina slurry composition. In an exemplary embodiment of the present invention, a second slurry composition having a second abrasive particle having a size substantially smaller than that of a first slurry composition may be used in the second polishing process, and attack due to the abrasive particles on a portion of the preliminary analysis sample that is to be polished in the second polishing process may be reduced, and complete removal of the analysis point by the second polishing process may be prevented.

When the first conductive line 123 is broken in the second polishing process, the signal inputted to the controlling part 400 may be changed. For example, a low signal may be inputted to the third conductive lines 128a and 128b that are electrically connected to the first conductive lines 122 and 123, respectively. A high signal may be inputted to third conductive lines 128c connected to the first conductive line 124. In such case, a current flows from the emitters to the collectors of the first and second bipolar transistors, but the current does not flow from the emitter to collector of the third bipolar transistor.

High and low signals may be inputted to the first AND logic circuit for example, as described above. High and low signals may be inputted to the second AND logic circuit. High and high signals may be inputted to the third AND logic circuits. The first and second AND logic circuits may output low signals. The third AND logic circuit may output a high signal. The high signal outputted from the third AND logic circuit may operate the third slurry provider. The slurry compositions may not be provided from the first and second slurry providers 402 and 404 when the low signal outputted from the first and second AND logic circuits.

When the first conductive line 123 is broken in the second polishing process, a third polishing process may be performed by supplying a third slurry composition having a third abrasive particle having a size substantially smaller than that of the second abrasive particle. The third slurry composition may be, for example, an alumina slurry composition or a ceria slurry composition. In an exemplary embodiment of the present invention, the third slurry composition having the third abrasive particle having a size substantially smaller than that of the second slurry composition may be used in the third polishing process, and attack due to the abrasive particles on a portion of the preliminary analysis sample that is to be polished in the third polishing process may be reduced, and complete removal of the analysis point by the third polishing process may be prevented.

When the first conductive line 124 is broken in the third polishing process, the signal inputted to the controlling part 400 may be changed. For example, a low signal may be inputted to third conductive lines 128a, 128b and 128c, and a current may flow from the emitters to collectors of the first and second bipolar transistors.

High and low signals are inputted to the first AND logic circuit, for example, as described above. High and low signals may be inputted to the second AND logic circuit. High and low signals may be inputted to the third AND logic circuit. The first to third AND logic circuits may output low signals so that slurry compositions may not be provided from the first to third slurry providers.

When the first conductive line 124 is broken, the analysis sample having a side from which the analysis point P is exposed is formed.

In an exemplary embodiment of the present invention, the analysis sample from which the analysis point P is exposed may be formed by using the substrate protecting member confirming the polished amount of the preliminary analysis sample while the preliminary analysis sample is polished, and a need to manually and repeatedly conform the polished amount of the preliminary analysis by using an optical microscope may be eliminated, and a time required for forming the analysis sample may be reduced, and the complete removal of the analysis point P due to an exceeding polish may be prevented.

In an exemplary embodiment of the present embodiment, the substrate protecting member 120 in FIG. 2 is employed to form the analysis sample. The substrate protecting member 130 shown in FIG. 3 may be employed to form the analysis sample. In a case that the substrate protecting member 130 is employed to form the analysis sample the second conductive lines are electrically connected to one another.

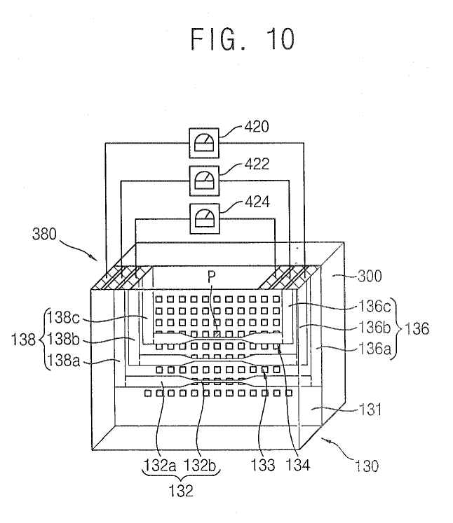

FIG. 10 is a schematic perspective view illustrating a method of forming an analysis sample using the substrate protecting member 130 of FIG. 3 according to an exemplary embodiment of the present invention.

The substrate protecting member 130 may include the first conductive lines 132, 133 and 134 that are substantially parallel with one another. To facilitate explanation, the reference numbers 132, 133 and 134 of FIG. 10 are associated with the first conductive lines in a direction away from the face of the substrate protecting member 130 that is initially polished.

The substrate protecting member 130 may be attached to a substrate 300 including an analysis point P The analysis point P may include an address in which either a deformity or an electrical failure is generated.

The substrate protecting member 130 may be attached to a side of the substrate 300 such that the substrate protecting member 130 is substantially in parallel with the side of the substrate 300. The substrate protecting member 130 may be attached to the substrate 300 such that a side portion included in one of the first conductive lines 132, 133 and 134 makes contact with an outer portion of the analysis point P. The second and third conductive lines 136 and 138 may extend to edges of the substrate protecting member 130 substantially opposite to the face of the substrate protecting member 130 that is to be polished.

In an exemplary embodiment of the present invention a side portion of the first conductive line 134 that is farthest from the face and is to be polished makes contact with the outer portion of the analysis point P In an exemplary embodiment of the present invention, an upper side of the center portion of the conductive line 134 having the first width substantially smaller than the second width makes contact with the outer portion of the analysis point P. In a case that the analysis point P is exposed from the polished face of the substrate protecting member 130 while polishing the substrate protecting member 130, the conductive line 134 making contact with the outer portion of the analysis point P may be broken.

A dummy wafer (not shown) may be attached to a back side of the substrate 300 to protect the substrate 300. A plurality of dummy wafers may be attached to the back side of the substrate 300.

The substrate 300 to which the substrate protecting member 130 is attached may be cut into a size suitable as an analysis sample so that a preliminary analysis sample 310 may be separated from the substrate 300. The substrate 300 may be cut by a cutter, such as for example, a diamond cutter.

A first detector 420 may be connected to the second and third conductive lines 136a and 138a connected to the first conductive line 132 to detect an electric signal. A second detector 422 may be connected to the second and third conductive lines 136b and 138b connected to the first conductive line 133 to detect an electric signal. A third detector 424 may be connected to the second and third conductive lines 136c and 138c connected to the first conductive line 134 to detect an electric signal. The first to third detector 420, 422 and 424 may include a device for measuring or applying a voltage and a current.

A predetermined voltage is applied to both end portions of the second and third conductive lines 136a and 138a using the first detector 420 to allow a first current to flow.

A first polishing process is performed with respect to the preliminary analysis sample 380 in a direction substantially perpendicular to a direction that the first conductive lines 132, 133 and 134 are extended. In the first polishing process, a polished portion of the preliminary analysis sample 380 is not adjacent to the analysis point P. A substantially large polishing rate may be used in the first polishing process.

In a case that the first conductive line 132 is broken in the first polishing process, the first current may not flow. A point of time when the first conductive line 132 that is nearest to the polished portion of the substrate protecting member 130 is broken may be obtained by detecting the first current in the first polishing process.

After the first conductive line 132 is broken, a predetermined voltage is applied to both end portions of the second and third conductive lines 136b and 138b by using the second detector 422 to allow a second current to flow. A second polishing process may be performed with respect to the preliminary analysis sample 380 at a polishing rate substantially smaller than that of the first polishing process.

In a case that the first conductive line 133 is broken in the second polishing process, the second current may not flow. A point of time when the second conductive line 133 is broken may be obtained by detecting the second current in the second polishing process.

After the first conductive line 133 is broken, a predetermined voltage is applied to both end portions of the second and third conductive lines 136c and 138c by using the third detector 424 to allow a third current to flow. A third polishing process may be performed with respect to the preliminary analysis sample 380 at a polishing rate substantially smaller than that of the second polishing process.

In a case that the first conductive line 134 is broken in the third polishing process, the third current may not flow. A point of time when the second conductive line 134 is broken may be obtained by detecting the third current in the third polishing process.

When the first conductive line 134 is broken, the polishing process is stopped so that the analysis sample having a side from which the analysis point P is exposed may be formed.

According to an exemplary embodiment of the present invention, an analysis sample from which the analysis point P is exposed is formed by using a substrate protecting member confirming the polished amount of a preliminary analysis sample while the preliminary analysis sample is polished, and a need to manually and repeatedly conform the polished amount of the preliminary analysis using an optical microscope may be eliminated. Thus, facility and effort of an operator are not required for forming the analysis sample. In addition, a time required for forming the analysis sample may be reduced.

Although exemplary embodiments of the present invention have been described in detail with reference to the accompanying drawings for the purpose of illustration, it is to be understood that the inventive processes and apparatus should not be construed as limited thereby. It will be apparent to those of ordinary skill in the art that various modifications to the foregoing exemplary embodiments can be without departing from scope of the invention as defined by the appended claims, with equivalents of the claims to be included therein.

What is claimed is:

1. A substrate protecting member comprising:
a protective layer attached to a semiconductor substrate to protect a defect portion of the semiconductor substrate; and
a sensing line including first, second and third conductive lines located on the protective layer, the first conductive line extending in a first direction, the second conductive line extending to an edge of the protective layer in a second direction different from the first direction, the third conductive line extending to the edge of the protective layer in the second direction wherein the second conductive line is electrically connected to a first end portion of the first conductive line, and wherein the third conductive line is electrically connected to a second end portion of the first conductive line.

2. The substrate protecting member of the claim 1, wherein the protective layer includes a glass.

3. The substrate protecting member of the claim 1, wherein the first, second and third conductive lines comprise at least one of doped polysilicon, aluminum, copper, titanium or gold.

4. The substrate protecting member of the claim 1, wherein end portions of the first conductive line adjacent to the second and third conductive lines have first widths, and wherein a central portion of the first conductive line has a second width substantially smaller than the first widths.

5. The substrate protecting member of the claim 1, further comprising a fourth conductive line substantially in parallel with the first conductive line, wherein first ends of the first and fourth conductive lines are electrically connected to the second conductive line, and wherein second ends of the first and fourth conductive lines are electrically connected to the third conductive line.

6. The substrate protecting member of the claim 1, further comprising a fourth conductive line and a fifth conductive line, wherein the first and fourth conductive lines are substantially in parallel with one another, wherein first ends of the first conductive lines are electrically connected to the second conductive line, and wherein second ends of the first conductive lines are electrically connected to the third conductive lines, respectively.

7. The substrate protecting member of the claim 1, further comprising a fourth conductive line, substantially in parallel with one another, wherein first and second ends of the first and fourth conductive lines are electrically connected to the second and third conductive lines, respectively.

8. A method of forming an analysis sample, the method comprising:
providing a substrate protecting member including a protective layer and a sensing line, the sensing line including a plurality of conductive lines located on the protective layer;
forming a preliminary analysis sample by attaching the substrate protective member to a substrate having an analysis point such that a first conductive line is electrically connected to an outer portion of the analysis point;
connecting electric signal detectors to end portions of a second and a third conductive line to detect electric signals transferred through the first to third conductive lines;
polishing the preliminary analysis sample in a direction substantially parallel with a direction that the first conductive line is extended;
determining whether the first conductive line is broken by determining a signal change in the electric signal detector; and
forming an analysis sample having a side from which the analysis point is exposed by stopping the polishing process when the first conductive line adjacent to the analysis point is broken.

9. The method of claim 8, wherein the electric signal detector measures and applies current and voltage.

10. The method of claim 8, wherein the substrate protecting member is attached substantially in parallel with a side of the analysis sample.

11. The method of claim 8, wherein a number of the first conductive lines is at least two, the first conductive lines being substantially in parallel with one another, and wherein the analysis point makes contact with the first conductive line that is farthest from an initially polished portion of the preliminary analysis sample.

12. The method of claim 11, wherein first ends of the first conductive lines are electrically connected to the second conductive line, and wherein second ends of the first conductive lines are electrically connected to the third conductive line.

13. The method of claim 12, wherein determining whether the first conductive line is broken includes:
measuring a current flowing through the first, second and third conductive lines after applying a predetermined voltage to the second and third conductive lines; and
detecting a change of the current flowing through the first, second and third conductive lines.

14. The method of claim 12, wherein the determining whether the first conductive line is broken includes:
measuring a voltage from the first, second and third conductive lines after applying a predetermined current to the second and third conductive lines; and
detecting a change of the voltage measured from the first, second and third conductive lines.

15. The method of claim 12, wherein the polishing the preliminary analysis sample includes:
performing a first polishing process using a first slurry composition until the first conductive line nearest to the initially polished portion of the preliminary analysis sample is broken; and
performing a second polishing process using a second slurry composition having a smaller abrasive particle than that of the first slurry composition until the first conductive line nearest to the initially polished portion of the preliminary analysis sample is broken.

16. A method of forming an analysis sample, the method comprising:
providing a substrate protecting member including a protective layer and a sensing line, the protective layer having a substantiatly plate shape, wherein the protective layer is substantially transparent and includes an insulating material, the sensing line including first, second and third conductive lines located on the protective layer, the first conductive line extending in a first direction, the second conductive line extending to an edge of the protective layer in a second direction different from the first direction, wherein the second conductive line is electrically connected to a first end portion of the first conductive line, the third conductive line extending to an edge of the protective layer in the second direction, wherein the third conductive line is electrically connected to a second end portion of the first conductive line;
attaching the substrate protective member to a substrate having an analysis point such that the first conductive line is electrically connected to an outer portion of the analysis point;
connecting a controlling part to end portions of the second and third conductive lines, the controlling part controlling operations of a polishing device using an electric signal provided through the first to third conductive lines;
polishing the preliminary analysis sample in a direction substantially parallel with a direction that the first conductive line is extended while driving the controlling part;
determining whether the first conductive line is broken using an electric signal generated from the controlling part to change a supply of a slurry composition; and
forming an analysis sample having a side from which the analysis point is exposed by stopping the polishing process when the first conductive line adjacent to the analysis point is broken.

17. The method of claim 16, wherein the second conductive line is electrically connected to a first end of the first conductive line.

18. The method of claim 16, wherein the controlling part includes:
a first switch receiving an electric signal from the third conductive line that is electrically connected to the first conductive line, the first switch controlling a first slurry provider of the polishing device according to whether the first conductive line is broken;
a second switch receiving electric signals from the third conductive line, wherein the third conductive line is electrically connected to the first conductive line and electrically connected to a fourth conductive line paired with the first conductive line, the second switch controlling a second slurry provider of the polishing device according to whether the first and fourth conductive lines are broken; and
a third switch receiving electric signals from the third conductive line, wherein the third conductive line is electrically connected to the fourth conductive line and electrically connected to a fifth conductive line paired with the fourth conductive line, the third switch controlling a third slurry provider of the polishing device according to whether the second and fifth conductive lines are broken.

19. The method of claim 18, wherein the first slurry provider supplies a slurry composition having a first abrasive particle, wherein the second slurry provider supplies a slurry composition having a second abrasive particle smaller than the first abrasive particle, and wherein the third slurry provider supplies a slurry having a third abrasive particle smaller than the second abrasive particle.

20. The method of claim 16, wherein end portions of the first conductive line adjacent to the second and third conductive lines have first widths, wherein a central portion of the first conductive line has a second width substantially smaller than the first widths, and wherein the substrate protecting member makes contact with an edge of the central portion of the first conductive line.

21. The method of claim 16, wherein the first, second and third conductive lines comprise at least one of doped polysilicon, aluminum, copper, titanium or gold.

22. The method of claim 16, wherein the protective layer making contact with the first conductive line includes a glass.

23. The method of claim 16, further comprising attaching a dummy wafer on a backside of the substrate.

24. The method of claim 16, wherein the substrate protecting member including the first conductive line is attached substantially in parallel with a side of the analysis sample.
